(19) United States
(12) Patent Application Publication
(10) Pub. No.: US 2014/0088774 A1
(43) Pub. Date: Mar. 27, 2014

(54) Configurable Baseline Calculation in Demand Response

(71) Applicant: SIEMENS AKTIENGESELLSCHAFT, Munich (DE)

(72) Inventors: Paul J. Bruschi, Princeton Junction, NJ (US); Sindhu Suresh, Monroe Twp, NJ (US); Sean Eade, Princeton, NJ (US)

(73) Assignee: SIEMENS AKTIENGESELLSCHAFT, Munich (DE)

(21) Appl. No.: 13/626,974

(22) Filed: Sep. 26, 2012

(51) Int. Cl. G05F 5/00

(52) U.S. Cl. 700/291

(57) ABSTRACT

A baseline editor is provided for creating a baseline calculator. A user interface allows description of the baseline algorithm in demand response domain terminology. A processor compiles the demand response domain terminology into computer code for calculating the baseline (i.e. a baseline calculator). Rather than relying on programmers to custom code the implementation of the baseline algorithm, the processor generates code based on demand response domain criteria. The entity creating the demand response program may utilize user interface to change the programming of the baseline algorithm to experiment in an effort to provide a desired incentive.

### BACKGROUND

The present embodiments relate to demand response. Demand response is used by utilities, aggregators, independent service operator, or other suppliers of electrical power to reduce electricity demand. The demand response market works on the principle of aggregation of negawatts based on a pool of participants, whom are enrolled in demand response programs. Demand response programs are designed to take specific actions to influence the load profiles of participating facilities (i.e., customers). A demand response event may be called to address a critical consumption period to maintain reliable electric service or avoid high electricity prices. The supplier tries to influence the demand by requesting participants to reduce (or shed) the load during the demand response event.

Using price, monetary incentives, or utility directives, utilities entice energy consumers to participant in demand response programs. The consumption of electric energy by customers is reduced from their expected or baseline consumption in response to an increase in the price of electric energy or to incentive payments. The baseline calculation estimates a customer's usual pattern of electricity load consumption outside of a demand response event. The baseline consumption is used to determine the amount of demand reduction and corresponding settlement. The baseline calculation may account for various dynamic factors in the calculation of the baseline consumption. For example, a customer's load consumption may be erratic on a holiday or a customer may deviate from regular consumption on a hot day. Thus, the baseline calculation attempts to determine the actual amount of load reduced during an event due to demand response rather than other factors.

Different methodologies for calculating the baseline consumption are adopted by different power providers. The main focus is on being able to obtain the customer's normal consumption pattern in the days prior to the demand response event, and then extrapolating this pattern to a day on which the demand response event is called. There is no single standard rule for the calculation of the baseline. The methodologies for calculating accurate baseline thresholds for triggering demand response compensation and sufficient measurement and verification protocols remain controversial among independent service operators, regional transmission organizations, utilities, aggregators or other power suppliers. As a result, different baseline calculations are created for different entities. Further, the entity may wish to have multiple baseline calculations from which to choose for an electricity consumer based on the characteristics of the consumer's consumption.

Electric consumers are encouraged to participate in a demand response program by entering into a contractual agreement that describes how the consumers are compensated. The contract is a textual document created by domain and business experts to describe the demand response program. The amount of compensation an electric consumer receives for participating in a demand response program is highly influenced by the baseline calculation. Demand response domain experts may work with software developers to create computer code for the baseline algorithm. However, creating this computer code is expensive, time consuming, and subject to communication failures between the domain experts and the software developers. Further, testing of the baseline algorithm code and the calculation results is time consuming and problematic because the baseline description is not formal.

### SUMMARY

In various embodiments, systems, methods and computer readable media are provided for configuring baseline calculation for a demand response program. A baseline editor is provided for creating a baseline calculator. A user interface allows description of the baseline algorithm in demand response domain terminology. A processor compiles the demand response domain terminology into computer code for calculating the baseline (i.e. a baseline calculator). Rather than relying on programmers to custom code the implementation of the baseline algorithm, the processor generates code based on demand response domain criteria. The entity creating the demand response program may utilize user interface to change the programming of the baseline algorithm to experiment in an effort to provide a desired incentive.

In a first aspect, a method is provided for configuring baseline calculation in demand response. A processor prompts entry of demand response parameters for defining a baseline algorithm for an electrical load. Different demand response parameters result in different baseline algorithms. The demand response parameters are received from a user input. The processor compiles a baseline calculator as a function of the demand response parameters. The baseline calculator is exported to a demand response controller.

In a second aspect, a non-transitory computer readable storage medium has stored therein data representing instructions executable by a programmed processor for configuring baseline calculation for a demand response program. The storage medium includes instructions for generating a baseline editor configured for configurable input of demand response domain specific terminology, receiving the demand response domain specific terminology input from the baseline editor, and interpreting the demand response domain specific terminology into code representing a baseline calculator.

In a third aspect, a non-transitory computer readable storage medium has stored therein data representing instructions executable by a programmed processor for configuring baseline calculation in demand response. The storage medium includes instructions for receiving programming for a demand response program in demand response terms from a user, the demand response terms being selectable for configuring the baseline calculation based on the programming obtained from the user, and compiling the baseline calculation from the programming, the baseline calculation converting consumption data from a customer into a baseline.

Any one or more of the aspects described above may be used alone or in combination. These and other aspects, features and advantages will become apparent from the following detailed description of preferred embodiments. The present invention is defined by the following claims, and nothing in this section should be taken as a limitation on those claims. Further aspects and advantages are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the embodiments. Moreover, in the figures, like reference numerals designate corresponding parts throughout the different views.

FIG. 1 is a flow chart diagram of one embodiment of a method for configuring baseline calculation in demand response;

FIG. 2 is a block diagram of one embodiment of a system for configuring baseline calculation in demand response; and

FIG. 3 illustrates another embodiment of a system for configuring baseline calculation in demand response.

### DETAILED DESCRIPTION OF EMBODIMENTS

Baseline calculation algorithms are configured for different types of demand response programs. These programs are under the control of a demand response management system (DRMS) controller. The DRMS controller provides functionality for the operation and settlement in demand response programs. The settlement data that the DRMS calculates is based on the difference between the calculated baseline and the actual load during a demand response event. The settlement data is used to calculate the financial compensation to the consumer for participating in the demand response program.

A domain specific language may be used to describe the baseline algorithm for different demand response programs. Different utilities or other power providers and consumers may use different demand response programs. Using domain specific language for the baseline calculation may allow for non-technical domain experts, those unfamiliar with the underlying software code and implementation of the DRMS, to thoroughly and accurately describe the baseline calculation. The domain specific language may be represented as text (e.g., a programming language specific to the demand response domain) or a graphical representation of the baseline, so may be comfortable for a domain expert to use.

Due to competition, demand response programs may become more complex or varied. A power provider may need to change the demand response program in response to competitive pressure. Specific baseline calculations may even be desired for individual customers. The time to market for the demand response program may be important to meet the changing needs of the power provider and/or the power consumer. Using demand response domain language to program the baseline calculation and a compiler to create corresponding computer code may allow for quick and economically developed baseline calculation. Development and testing time may be reduced. There may be a reduced risk of producing the wrong algorithm due to improper coding, so that the demand response program produces expected billing and business results.

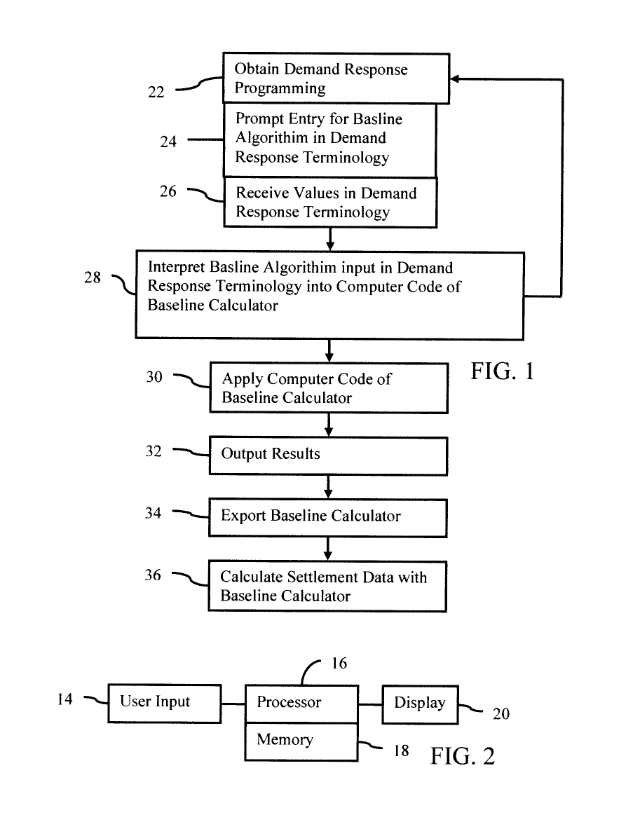

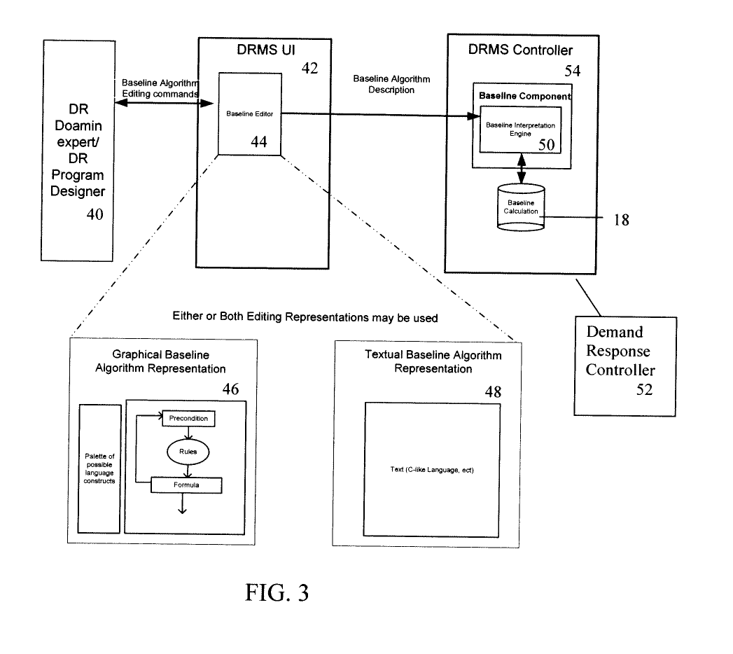

FIG. 1 shows a method for configuring baseline calculation in demand response. The method is implemented by the system of FIG. 2, the system of FIG. 3, and/or a different system. A processor performs some or all of the acts. User inputs, a communications network, other processors, a database, or other devices may be used in performing the acts.

Additional, different, or fewer acts may be provided. For example, act 22 is performed without acts 24 and 26. As another example, acts 22 and 28 are performed without other acts. In another example, acts 34 and 36 are not performed.

The method is provided in the order shown. Acts 22, 24, 26, and 28 may be performed sequentially. The acts may be repeated in parallel or sequentially. Similarly, acts 30, 32, 34, and/or 36 may be performed in parallel or sequentially for different baseline calculators.

The acts are performed in the context of power supply. A power source supplies power to load devices of a consumer. During high demand, the consumer may be requested to reduce the load caused by the load devices, such as turning off non-essential lighting or changing temperature thresholds for heating or air conditioning. To determine the amount of reduction during a demand response event, a baseline representing typical usage to compare with actual usage is calculated. The calculation of the baseline depends on various factors.

In act 22, programming for a baseline algorithm is obtained. The information gathered is in demand response terms. The terminology of the demand response domain is used for describing the baseline algorithm. For example, the baseline algorithm descriptions of the Pennsylvania New Jersey Maryland (PJM) independent service organization (ISO) defines a baseline calculation in section 3.3A.2 Customer Baseline Load. The textual description of this algorithm uses demand response domain terminology. For example, “the CBL for weekdays shall be the average of the highest 4 out of the 5 most recent load weekdays in the 45 calendar day period preceding the relevant load reduction event. i. For the purposes of calculating the CBL for weekdays, weekdays shall not include: 1. NERC holidays; 2. Weekend days; 3. Event days. For the purposes of this section an event day shall be any weekday that an Emergency Load Response Participant submits a settlement pursuant to Section 3.3A.4 or 3.3A.5, provided that Event Days shall exclude such days if the settlement is denied by the relevant LSE or electric distribution company or is disallowed by the Office of the Interconnection; 4. Any weekday where the average daily event period usage is less than 25% of the average event period usage for the five days. ii. If a 45-day period does not include 5 weekdays that meet the conditions in subsection (a)(i) of this section, provided there are 4 weekdays that meet the conditions in subsection (a)(i) of this section, the CBL shall be based on the average of those 4 weekdays. If there are not 4 eligible weekdays, the CBL shall be determined in accordance with subsection (iii) of this section. iii. Section 3.3A.2(a)(i)(3) notwithstanding, if a 45-day period does not include 4 weekdays that meet the conditions in subsection (a)(i) of this section, event days will be used as necessary to meet the 4 day requirement to calculate the CBL, provided that any such event days shall be the highest load event days within the relevant 45-day period. (b) The CBL for weekend days and NERC holidays shall be determined in accordance with the following provisions.” Other definitions, with the same, similar, or different demand response terminology may be used.

This terminology is not an equation that may be readily implemented by a computer. Even though an algorithm may be written, the description is in words and therefore is subject to interpretation by software developers, system testers, domain response program designers and other domain experts. To implement the algorithm, a programmer may incorrectly code the equation. The programmer may not provide a final product without a long software development and testing period.

Instead, the textual algorithm is treated as or converted to a high-level programming language. The high-level programming language uses the same or similar terminology. The compilation from the programming language is automated so that the power and responsibility for creating the algorithms is with the creator of the demand response program rather than a third party programmer. The provider of the demand response management system provides a software tool and training for creating and crafting baselines, but the responsibility for creation is with the user of the demand response management system (e.g., the independent service operator, the regional transmission organization, utility, or aggregator).

The tool obtains the programming from the user's domain and business experts. The experts craft the demand response program using demand response terminology, allowing creation as needed and testing to make sure the demand response program is fair to both the utilities and utility customers.

The demand response terms are selectable for configuring the baseline calculation based on the programming obtained by the user. In act 24, the user is prompted to enter demand response parameters. The demand response parameters are any constructs, options, or settings for demand response. The collection of demand response parameters provides a baseline algorithm for electrical loads in demand response terminology.

The demand response parameters indicate selection of one or more options. Different demand response parameters are available in the demand response terminology. The demand response parameters may be for a same construct, such as different units of measurement. The demand response parameters may be for different approaches (e.g., whether to use a construct), such as for using exclusions or not. The demand response parameters may be for different settings for a selected approach, such as the number of days required to establish a baseline or to exclude for filtering being seven. Any demand response parameters may be provided.

A processor prompts the user. The prompt is by requesting information, such as through a menu or series of guided questions. The prompt may be a request for linking to a file. The prompt solicits input by providing a location for input. More active prompting may be used, such as highlighting, warning, or notifying.

In other embodiments, presenting a baseline editor on a display prompts the user for the programming. The display of the baseline editor indicates to the user that programming may be entered. A baseline editor for configurable input of demand response domain specific terminology is generated as part of a user interface. The baseline editor accepts input of different baseline algorithms. The editor is for entry of new programming or for changing existing programming. Using a user input, the user adds the programming, such as by entry, selection, or transfer, to the baseline editor.

Any type of programming may be used for the baseline editor. For example, the user is prompted to input graphical and/or textual programming using demand response terms. For graphical programming, a visual programming interface is generated. Templates may or may not be provided. A palette or menu of graphical constructs may be provided, such as displayed in one region of the baseline editor. The user may scroll or otherwise navigate through different demand response options graphically represented for addition to a visual programming flow chart or field. The demand response constructs are labeled with demand response terms, such as a precondition, rule, or formula. Selection of a construct may prompt further selection, such as for associated settings and/or selection of options for the selected construct. The user places the selected constructs in a workflow or other visual representation to generate the baseline calculation. The visual programming may include limitations, such as which constructs may be connected and/or in what way with other constructs.

In another example, a textual programming interface is generated as the baseline editor. A region or text entry field is provided to prompt entry of textual programming. The textual programming is a high-level programming language specific to the demand response domain. For example, C++ is a high level programming language for computing. Rather than requiring knowledge of C++, the user may enter terms associated with the demand response domain. A menu, help system, or other guidance may assist the user in textual programming, such as by providing a list of commands to be used. In alternative embodiments, the textual programming is obtained by prompting linking or uploading of a file.

The visual, textual, or other programming prompts entry of the demand response parameters in terminology of the demand response domain. The programming interface uses programming language based on demand response terminology. For example, “demand response event=critical peak pricing” is input as textual programming demand response parameters. As another example, “load point offset=average of five days prior and five days after x [adjustment formula]” is input as textual programming demand response parameters. The visual programming interface uses programming language based on demand response terminology, such as visual graphics being demand response parameters labeled in the terminology (e.g., a box labeled as “demand response event.” The demand response domain provides the programming language and limits the available language for programming the baseline calculation.

In act 26, demand response parameters in the demand response terminology are received. Using a user input, the user enters the programming. For example, the user (e.g., a demand response domain expert) enters text or visual programming information into a baseline editor. The baseline editor performs any checks for proper entry.

The entered programming indicates the demand response parameters (e.g., constructs, options for the constructs, and/or settings for the constructions or options). The selection of demand response parameters indicates the baseline calculation desired by the user. Different demand response parameters result in different baseline algorithms. The demand response parameters represent selections associated with language constructors. Any options or constructors may be included in the programming. The demand response parameters represent text, graphics, numbers, or other indication of the programming. The parameters define the demand response calculation.

One example constructor and example corresponding options or settings include baseline preconditions, such as the units of measurement in which to calculate the baseline (e.g., KW or KWH).

The get history formula may be a constructor, such as defining how many days of historic meter data to obtain (e.g., ten days), and how many days are to be used for the normal baseline calculate case (e.g., four days of the ten obtained days).

Settlement rules, such as demand response parameters for how to calculate the difference between the actual loads and calculated baseline, may be provided as a constructor. Different rules with or without configuration options may be used. Different adjustments or relationships for determining the financial incentive is provided.

Another constructor is the day chooser formula. For example, week days only using week days in the past, Saturdays only using Saturdays in the past, Sundays and holidays only using Sundays and holidays in the past, all days being used together, Saturdays and Sundays being used together, or other formulas for choosing days maybe provided. The day chooser formula may allow selection of one or more options for excluding days, such as excluding prior event days unless there are an insufficient number of normal load days.

The event description is a constructor for defining the demand response event. For example, the event may be defined as part of a critical peak pricing (CPP), peak time rebate (PTR), or other event program. Demand response parameters for how to use the demand response event may be selected, such as whether to weight, subtract, add, multiply, divide, other action, select formula, or branch in baseline calculation based on the event program.

A constructor for a normalization algorithm may be provided. The normalization may define filtering of the historic load measures. The filtering handles outliers, such as dropping the highest and/or lowest average load over the event period in the historic meter.

An averaging formula may be a constructor. The averaging formula may be configured to calculating the averages over the event period (e.g., noon-5 pm for a demand response event) for each of the selected days and replace particular days that do not satisfy a particular valid average. The replacement demand response parameter may be defined.

Another constructor is the adjustment offset. Load point adjustments may be defined. For example, an average for each increment, such as 30 minutes, in a demand response event is determined. The average is adjusted by prior and/or subsequent averages. Weather sensitive adjustments may be defined. The formula and weather information used may be selected. The algorithms that are used to calculate the adjustments and when to apply the adjustments may be defined.

Exception handling to the rules may be a constructor. Options include dealing with an invalid number of available historic days. Different levels of quality may be provided, such as substituting one or a given number of invalid days with demand response parameters from other days to provide a valid, but low quality, data. The low quality may be configured to alter the settlement rule, normalizing, averaging, and/or adjustment offset constructors or demand response parameters.

Another constructor may be baseline performance rules. Trends in previously calculated baselines are compared to the currently calculated load. Trends may be used to update or adjust the baseline. The formula, days, and adjustment for the trend may be set. Other performance rules than trending may be used, such as a deviation limitation.

Yet another example constructor is data quality rules. For example, the results of a lack of sufficient valid historic days on quality and/or the effect of different levels of quality may be set. A notification of quality may be generated. A quality or limitation being exceeded may be used to determine outcome, such as indicating an invalid baseline calculation in some situations.

Constructors for data access and/or data output may be provided. The options or settings for obtaining historical load data specific to a power provider and/or consumer may be configured through the programming. The output, billing, or format appropriate for a given power provider and/or consumer may be configured through the programming.

Other constructors, constructor options, and/or corresponding settings may be provided, selected, and/or received. Other examples of options for a given constructor may be used. The same constructors but with different options and/or settings may be selected. A sufficient number of constructors and corresponding options are included in the programming language to allow creation of a wide variety of baseline calculators. The baseline calculators are implemented as compiled baseline algorithms. If the programming does not allow for a desired option or constructor, the programming language may be updated or altered to add the desired option or constructor.

The received demand response parameters are for defining a new baseline calculator. The prompted programming is associated with creating the baseline calculator from scratch or a clean slate. Alternatively, a template is used. The template may include example constructors, options, and/or settings or may be a framework without particular demand response parameters being selected. In yet other embodiments, the received demand response parameters are for editing a previous demand response parameter. The programming for an existing baseline calculator is altered, resulting in a new baseline calculator once compiled. For example, the number of historical days for a high quality baseline calculation is changed from ten days to eight days.

In act 28, the demand response domain specific terminology is interpreted into code. The programming in the demand response domain language is converted into computer code or logic for a computer or processor. The converted computer code represents a baseline calculation for demand response in provision of electrical loads. Using the code, the computer may convert load data from a customer into a baseline load.

The processor automatically compiles the baseline calculation from the programming. The demand response parameters represented by the programming are used to determine the equation and/or other logic for calculating the baseline from load data. The demand response parameters (e.g., source programming or source code) are converted into a target language, such as object code, to create an executable program.

The processor compiles the programming into assembly or machine language, but may instead be a translator between different high-level languages and use another compiler to convert from one of the high-level languages to object code. The compiler bridges the source programming in the demand response terminology with the underlying hardware. The processor performs lexical analysis, preprocessing, parsing, semantic analysis, syntax-directed translation, code generation, and/or code optimization. In one embodiment, the processor determines the correctness of the syntax of the programming (e.g., front end), generates object code, performs run-time organization, and/or format output according to assembler and/or linker conventions. The processor checks whether the program is correctly written in terms of the programming language syntax and semantics. Errors, if any, are reported. An intermediate representation of the source code may be generated for optimization. In optimization, useless or unreachable code may be removed; constant values may be identified and propagated; and computation may be organized based on the context. Another intermediate representation may be generated from the optimized representation for translating into assembly code. Target instructions are selected for each instruction of the optimized intermediate representation. Processor registers are assigned to the program variables where possible. Conversion for parallel execution may be performed.

Based on demand response domain knowledge built into the compiler, the compiler determines logic functions to implement the programming. For example, a logic function for each possible programming demand response parameter is provided. Since the demand response parameters are associated with demand response terminology, the domain knowledge is built into the compiler. The processor selects the logic functions and order based on the programming. The selected components of the baseline calculation in the demand response terminology are converted into logic for accessing and processing customer load data. The demand response terms are converted into computer code. The domain specific terms are converted into mathematical, computer implemented code. The selected constructs, options, and settings associated with the domain specific parameters are used to form the equation, such as assigning certain numbers to variables (settings) in certain equations or logic (options) for performing certain types of functions (constructs).

The compiled equation (s) and/or logic are the baseline calculator. The received demand response parameters for the demand response domain are converted into computer code for calculating a baseline from user load data. Rather than requiring manual definition of the baseline calculator, the processor compiles the baseline calculator from demand response domain terminology. No user input other than in the baseline editor is needed. Other input may be used, such as for obtaining data or outputting results. An expert in demand response rather than a programmer may create any number of baseline calculators with any desired variations.

In the feedback from act 28 to 22, the acts 22, 24, 26, and/or 28 are repeated. The repetition of the obtaining (e.g., the prompting and receiving) and interpreting provides a different baseline calculator where different constructors, options, settings, and/or other demand response parameters are chosen. Other repetitions may be provided. For example, a given baseline calculator is applied and/or results of the applying output in acts 30 and 32 before creating the next baseline calculator. As another example, the baseline calculator is exported in act 34 and used for calculating settlements in act 36 before creating the next baseline calculator. The next baseline calculator may be completely new or may be a modification once a concern with settlements or a change in needs is identified.

The repetition may be used for comparison. Multiple baseline calculators are created so that the differences in settlement or baseline calculation are viewed. The repetition may be used for modification, such as changing one or more demand response parameters (e.g., constructors, options, or settings), to an existing baseline calculator in an effort to refine. Since programming in demand response terminology is used with an automatic or processor performed compiling, a utility or other designer of demand response programs may experiment and rapidly test the results of many different baseline calculators.

In act 30, the baseline calculator is applied. The baseline calculator is tested. A sample collection of load data is used to apply the baseline calculator. For example, load data from a database of one or more actual power consumers is accessed by the baseline calculator. The load data is associated with, such as includes, one or more demand response events. The baseline calculator calculates the baseline or baselines from the load data. Settlements may alternatively or additionally be calculated using the baseline calculator.

The same load data may be used for application of different baseline calculators. The baseline calculators may be compared. Alternatively, different load data is used for different baseline calculators, such as where the baseline calculators are created for different situations, different consumers, or different programs.

In act 32, the results of the application of the compiled baseline calculator to the load data are output. The output is a display, report, or transmission.

One or more types of information may be output. The results may be a settlement or settlements. Other results are the baseline load over any time period. For example, a graph, chart, or table of baseline load over time is output with any desired interval.

The output is for one baseline calculator. For comparison, the same output may include results for multiple baseline calculators. For example, the settlements or settlements over different demand response events are output on a same display. As another example, graphs of baseline load over time from different baseline calculators are output in a same frame of reference, such as with the same x and y axes or in a same graph field.

Utilities or other power suppliers may use the baseline editor and resulting baseline calculators to offer state of the art demand response programs to their customers. The state of the art in demand response programs may vary over time or for different situations, such as for smart grids verses traditional power networks. Offering demand response programs that will entice customers may provide competitive advantage and/or assist with load balancing. In order to make such programs feasible, a fair compensation is to be calculated. Offering a one size fits all solution in calculation of baselines may not be sufficient to meet utility and customer needs. Thus, easy to use and understand baseline calculation domain specific language programming may allow utilities and others to respond more quickly to changing needs.

In act 34, the baseline calculator is exported. For example, the processor used to compile the baseline calculator is different than the processor used to implement the demand response program. The computer or workstation used to create the baseline calculator exports the baseline calculator to a server, computer, or workstation, such as a demand response controller, to calculate settlements for participating consumers. A billing computer or system may receive the baseline calculator for implementation. In alternative embodiments, the demand response controller generates the baseline editor, interprets the domain specific programming, and implements the baseline calculations, so no export to another device is used. The export is a change in status from development of the baseline calculator to use for the demand response program.

The export is by transfer over a network. In other embodiments, uploading, storing to memory, or other transfer is used.

In act 36, the demand response controller calculates baseline loads for demand response events using the baseline calculator. In response to a demand response event, the load is calculated. The historical data for each customer is gathered on an ongoing basis or in response to the demand response event. The historical data is used by the baseline calculator to determine the baseline. The demand response controller determines the reduction in load by each participating customer based on the baseline. The baseline is used to determine the difference in load. Using settlement rules, the financial reduction or other change in billing for the customer is determined from the baseline and the actual load during the demand response event. The baseline calculator may include determination of the settlement data or may determine the baseline without determining the settlement data.

FIG. 2 shows a block diagram of a system for configuring baseline calculation in demand response. The system includes a user input 14, a processor 16, a memory 18, and a display 20. Additional, different, or fewer components may be provided. For example, a network interface, such as a network card or wireless transceiver is provided. As another example, a printer and/or other output device is provided.

The user input 14, processor 16, memory 18, and/or display 20 are part of a computer, personal computer, server, workstation, network processor, or other now know or later developed processing system. The processing system has access to meter readings from meters for power consumption. The readings and other load data are in the memory 18 or accessed from another memory. Various peripheral devices such as, for example, the display 20, a printing device, a disk storage device (e.g., a magnetic or optical disk storage device), and the user input (e.g., a keyboard and a mouse) may be operatively coupled to the processor 16.

A program may be uploaded to, and executed by, the processor 16. Likewise, processing strategies may include multiprocessing, multitasking, parallel processing and the like. The processor 16 is implemented on a computer platform having hardware such as one or more central processing units (CPU), a random access memory (RAM), and input/output (I/O) interface(s). The computer platform also includes an operating system and microinstruction code. The various processes and functions described herein may be either part of the microinstruction code or part of the program (or combination thereof) which is executed via the operating system. Alternatively, the processor 16 is one or more processors in a network.

The instructions, user input (map confirmation or alteration), rules, and/or other information are stored in a non-transitory computer readable memory, such as the memory 18. The memory 18 is an external storage device, internal storage device, RAM, ROM, and/or a local memory (e.g., solid state drive or hard drive). The same or different computer readable media may be used for the instructions and other data, such as the historical load data, compiler information, and baseline editor information. The memory 18 may be implemented using a database management system (DBMS) managed by the processor 16 and residing on a memory, such as a hard disk, RAM, or removable media. Alternatively, the memory 18 is internal to the processor 16 (e.g. cache). The memory 18 stores programming, load data, or other data used for or output from creating and/or using a baseline calculator.

The instructions for implementing the processes, methods and/or techniques discussed herein are provided on computer-readable storage media or memories, such as a cache, buffer, RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination.

In one embodiment, the instructions are stored on a removable media device for reading by local or remote systems. In other embodiments, the instructions are stored in a remote location for transfer through a computer network or over telephone lines. In yet other embodiments, the instructions are stored within a given computer, CPU, GPU or system. Because some of the constituent system components and method acts depicted in the accompanying figures are preferably implemented in software, the actual connections between the system components (or the process steps) may differ depending upon the manner in which the present embodiments are programmed.

The computer processing performed by the processor 16 may be implemented in various forms of hardware, software, firmware, special purpose processors, or a combination thereof. Some embodiments are implemented in software as a program tangibly embodied on a non-transitory program storage device. By implementing with a system or program, configuring the baseline calculation is performed by the processor 16 with programming input by a user. For example, the acts of FIG. 1 are performed by the processor 16 with a user input 14. In alternative embodiments, some acts are performed by other processors, such as the calculation of settlements in act 36 being performed by a settlement processor.

FIG. 3 shows another embodiment of a system for configuring baseline calculation in demand response. The system of FIG. 3 represents hardware, software functions, and a user. The demand response domain expert 40 uses the user interface 42 of the demand response management system controller 54 to create a baseline calculator. The baseline calculator may be implemented by the demand response management system controller 54 or used by a separate demand response controller 52 for calculating settlements for consumers. Additional, different, or fewer components may be provided.

The demand response expert 40 is knowledgeable in the demand response domain without being or with lesser knowledge in computer programming. The expert 40 is tasked with designing a demand response program and the baseline algorithm used to support the demand response program. Rather than writing down criteria and providing those criteria to a computer programmer, such as at a third party programming service, the expert 40 may create their own baseline calculator for implementation by a computer or processor. The expert 40 may work for the utility, independent service operator, regional transmission organization, aggregator, or other supplier of power rather than for a computer programming company. In alternative embodiments, a third party service provides the programming in the demand response domain.

The user interface 42 presents a baseline editor 44. The demand response expert 40 activates or runs the baseline editor 44. The baseline editor 44 includes menus, fields, or other displays for input or change of the demand response criteria by the expert 40. For example, a graphical representation 46 is generated. A palette of different constructs is displayed for selection and addition to a field representing the baseline calculation. The constructs use terminology of the demand response domain, so are familiar to the expert 40. Adding a construct to the field may trigger presentation of different options and/or settings for the field. Alternatively, the palette includes the same types of constructs but with different option and/or setting configurations for adding to the field.

In another example, a textual representation 48 is generated. A field or other input for text is displayed. The expert 40, using a guide, knowledge, or other source of information, enters text. The text includes operators from the demand response domain. The operators are labeled with terms from the demand response field. The operators available may be located by the demand response expert 40 by using demand response terminology, such as selecting from an alphabetical listing of demand response operators. Using examples or knowledge, the expert 40 enters the text in the demand response programming language. The operators for different constructs may be assembled into a program. The options and/or settings for the construct are added to the operators as appropriate.

The baseline editor 44 is used by the expert 40 to create programming representing the desired baseline calculator. The programming uses terms from the demand response field.

The demand response programming is compiled by the demand response management system controller 54 (e.g., the processor 16). The baseline interpretation engine 50 converts the programming into code usable by a computer to calculate baseline load. The code is stored as the baseline calculator in the memory 18.

The expert 40 activates the interpretation or the interpretation occurs as the expert 40 creates the programming with the user interface 42. Based on terminology familiar to the demand response expert 40, computer code that may be acted upon by a computer is generated. This arrangement allows the expert 40 to create useable computer code without being a programming expert.

The demand response controller 52 or the demand response management system controller 54 uses the baseline calculator to calculate the baseline for demand response events. By access to the memory 18 or through transfer of the compiled code, the baseline calculator is available for use in a demand response program. The use may be for testing, comparison, and/or implementation in an active demand response program.

Various improvements described herein may be used together or separately. Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. A method for configuring baseline calculation in demand response, the method comprising:
prompting, with a processor, entry of demand response parameters for defining a baseline algorithm for an electrical load, different combinations of parameters resulting in different baseline algorithms;
receiving, from a user input, the demand response parameters;
compiling, with the processor, a baseline calculator as a function of the demand response parameters; and
exporting the baseline calculator to a demand response controller.

2. The method of claim 1 wherein prompting comprises presenting a baseline editor on a display.

3. The method of claim 1 wherein prompting comprises displaying a text entry field.

4. The method of claim 1 wherein prompting comprises displaying a palette of constructs for visual programming of the baseline algorithm.

5. The method of claim 1 wherein prompting comprises prompting the entry of the demand response parameters in terminology of a demand response domain, wherein receiving comprises receiving the demand response parameters in the terminology of the demand response domain, and wherein compiling comprises converting the demand response parameters in the terminology of the demand response domain into computer code for calculating a baseline from user load data.

6. The method of claim 1 wherein receiving comprises receiving at least one of the demand response parameters as an edit from a previous demand response parameter.

7. The method of claim 1 wherein prompting comprises prompting selection of a precondition, days of the week, weather condition, and filtering.

8. The method of claim 7 wherein receiving comprises receiving a unit of measurement as the precondition, separation of weekdays from Saturdays and Sundays as days of the week, an adjustment for the weather condition, and an outlier removal as the filtering.

9. The method of claim 1 wherein compiling comprises forming an equation from the demand response parameters, the equation comprising the baseline calculator.

10. The method of claim 1 wherein compiling comprises converting, by the processor, domain specific terms into mathematical, computer implemented code.

11. The method of claim 1 wherein exporting comprises transferring the baseline calculator to the demand response controller; and
further comprising calculating customer settlements, by the demand response controller, as a function of the baseline calculator and historical load data.

12. The method of claim 1 further comprising:
repeating the prompting, receiving, and compiling, providing an additional baseline calculator;
applying the baseline calculator and the additional baseline calculator; and
outputting results of the applying.

13. In a non-transitory computer readable storage medium having stored therein data representing instructions executable by a programmed processor for configuring baseline calculation in a demand response program, the storage medium comprising instructions for:
generating a baseline editor configured for configurable input of demand response domain specific terminology;
receiving the demand response domain specific terminology input from the baseline editor; and
interpreting the demand response domain specific terminology into code representing a baseline calculator.

14. The non-transitory computer readable storage medium of claim 13 wherein generating comprises generating a visual programming interface as the baseline editor.

15. The non-transitory computer readable storage medium of claim 13 wherein generating comprises generating a textual programming interface as the baseline editor, the textual programming interface including terminology limitations for the demand response domain specific terminology.

16. The non-transitory computer readable storage medium of claim 13 wherein receiving comprises receiving selection of a settlement rule and a history formula.

17. The non-transitory computer readable storage medium of claim 13 wherein interpreting comprises converting selected components into logic for accessing data and calculating the baseline from the data.

18. The non-transitory computer readable storage medium of claim 13 wherein generating comprises generating the baseline editor to accept input of different baseline algorithms.

19. In a non-transitory computer readable storage medium having stored therein data representing instructions executable by a programmed processor for configuring baseline calculation in demand response, the storage medium comprising instructions for:
receiving programming for a demand response program in demand response terms from a user, the demand response terms being selectable for configuring the baseline calculation based on the programming obtained from the user; and
compiling the baseline calculation from the programming, the baseline calculation converting consumption data from a customer into a baseline.

20. The non-transitory computer readable storage medium of claim 19 wherein receiving comprises obtaining graphical or textual programming using the demand response terms, and wherein compiling comprises converting the demand response terms into computer code.

21. The non-transitory computer readable storage medium of claim 19 further comprising repeating the receiving with different programming for a different demand response program, and outputting results from application of the baseline calculation to the load data for the programming and the different programming.
